(19) United States
(12) Patent Application Publication
(10) Pub. No.: US 2009/0218315 A1
(43) Pub. Date: Sep. 3, 2009

(54) METHOD AND SYSTEM FOR CONTROLLING CENTER-TO-EDGE DISTRIBUTION OF SPECIES WITHIN A PLASMA

(76) Inventor: Steven Shannon, Raleigh, NC (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/038,921

(22) Filed: Feb. 28, 2008

(51) Int. Cl. B44C 1/22; C23F 1/08

(52) U.S. Cl. 216/64; 156/345.24

(57) ABSTRACT

A method and system for controlling the center-to-edge distribution of a species within a plasma is provided. In one embodiment, the invention provides a method for plasma processing, comprising determining plasma processing center-to-edge profile requirements of a substrate, and selecting a ratio of two inert gases to be provided to a plasma processing chamber in response to the plasma processing center to edge profile requirements.

### FIELD

Embodiments of the present invention generally relate to plasma processing technologies and, more specifically, to a method and system for controlling the center-to-edge distribution of species within a plasma.

### BACKGROUND

In complex plasma processing processes, such as plasma etching integrated circuits, precise control of various process parameters is required for achieving consistent results within a substrate, as well as the results that are reproducible from substrate to substrate. As the geometry limits of the structures for forming semiconductor devices are pushed against technology limits, tighter tolerances and precise process control are critical to fabrication success. However, with shrinking geometries, precise critical dimension and etch process control has become increasingly difficult. During processing, changes in the distribution of plasma species across the substrate may be detrimental to etch rate and uniformity, material deposition, step coverage, feature taper angles, and other parameters critical to the fabrication of semiconductor devices. There is currently no in-situ means available for controlling the center-to-edge distribution of a plasma species over a substrate during plasma processing.

Accordingly, there is a succinct need in the art for an improved method and system for controlling the center-to-edge distribution of species within a plasma.

### SUMMARY

Methods for controlling distribution of species in a plasma is provided. In one embodiment, a method for plasma processing includes determining plasma processing center-to-edge profile requirements of a substrate, and selecting a ratio of two inert gases to be provided to a plasma processing chamber in response to the plasma processing center to edge profile requirements.

In another embodiment, a method for plasma processing a substrate includes determining center-to-edge plasma processing requirements, providing a gas mixture having a ratio of two inert gases selected to regulate a spatial distribution of species within a plasma, the ratio selected in response to the center-to-edge processing requirements, and plasma processing the substrate in the presence of a plasma formed from the gas mixture.

In yet another embodiment, a plasma processing system is provided that includes a chamber body suitable for maintaining a vacuum therein, a substrate support disposed in an internal volume of the chamber body, a gas distribution system configured to provide a gas mixture to the internal volume of the chamber body, a power application system configured to maintain a plasma formed from the gas mixture within the internal volume of the chamber body, a controller coupled to the gas distribution system, and computer readable media. The computer readable media contains instructions which, when executed by the controller, cause the processing system to perform a plasma process on a substrate disposed on the substrate support. The process comprises providing a gas mixture from the gas distribution system to the internal volume, wherein the gas mixture has a ratio of two inert gases selected to regulate a spatial distribution of species within a plasma, responsive to center to edge plasma processing requirements. Power suitable to maintain a plasma formed form the gas mixture is then provided from the power application system, and a substrate is plasma processed in the presence of the plasma formed from the gas mixture.

The ratio of inert gases may also be selected to tune plasma standing have effects.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 is a schematic diagram of an exemplary plasma enhanced processing chambers in which embodiments of the invention may be practiced;

FIG. 2 depicts a method for plasma processing according to an embodiment of the invention; and

FIGS. 3A-C depict qualitative results of exemplary embodiments.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention generally include methods for controlling the center-to-edge distribution of species within a plasma by altering a ratio of inert gases comprising the plasma. In one embodiment, a ratio of two inert gases utilized to form a plasma in a processing chamber is selected to regulate the spatial distribution of the species disassociated from the inert gases, and thereby electron and ion density profile within the plasma. In an exemplary embodiment, the inert gases comprise a mixture of Argon (Ar) and Xenon (Xe), with one inert gas present in a trace amount with respect to mixture. A trace amount of Xe is utilized, for example, to comprise less than about 15 percent by volume of the gas mixture. However, it is contemplated that other combinations of inert gases and mixture ratios thereof may be utilized to advantageously alter a plasma species profile, including combinations wherein an added species need not be a trace. Thus, it is fully envisioned that the invention may be implemented utilizing any gas mixture and ratio thereof to form plasma species, to suit any plasma processing or other application that would benefit from adjusting plasma density profile.

In another embodiment, an etchant gas may be included with the two inert gases to regulate its plasma density profile. In one example of the referenced embodiment, the plasma still comprises a mixture of Ar and Xe, but additionally includes an etchant such as an oxygen containing gas or a halogen containing gas, among others. Exemplary oxygen containing gases include, but are not limited to O₂, O₃ and CO. Exemplary halogen containing gases include, but are not limited to, HF, Cl₂, HCl, CF₄ and the like.

The methods described herein are illustratively presented in terms of a plasma etch application. However, the methods are equally suitable for use in other plasma processes, which could include, but are not limited to, physical vapor deposition, plasma enhanced chemical vapor deposition, plasma ion implantation, plasma film treatment, and/or any process where it is desirable to control a plasma center-to-edge species distribution.

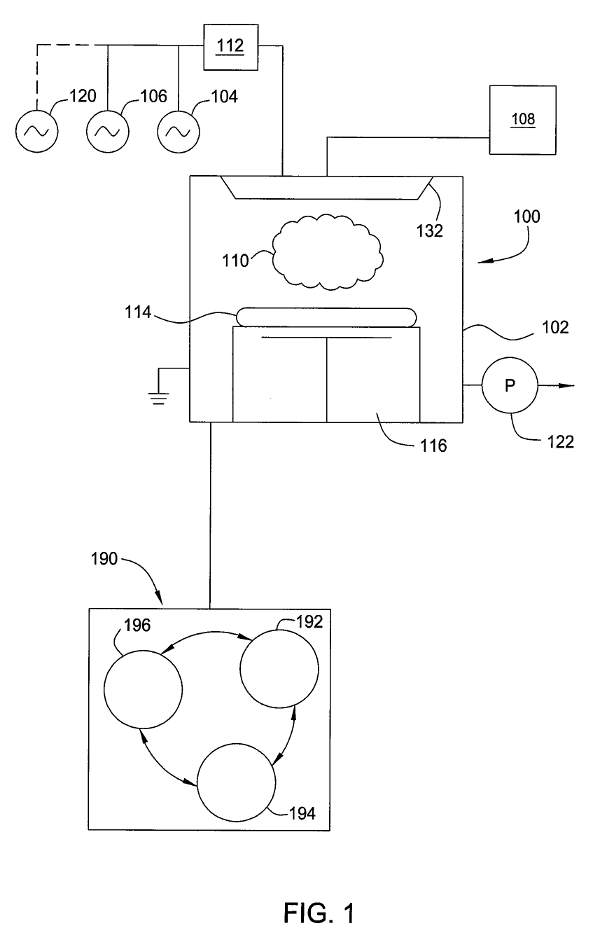

FIG. 1 depicts an exemplary schematic diagram of a plasma processing chamber 100 in which various embodiments may be carried out. One particular example of plasma etch chambers that may be adapted to benefit from present embodiments includes, but is not limited to, the ENABLER® processing chamber, available from Applied Material, Inc., located in Santa Clara, Calif. It is contemplated that other plasma chambers, including those available from other manufacturers, may be adapted to practice the invention. Although the plasma processing chamber 100 illustratively described in FIG. 1 is configured as an etch chamber, various embodiments may be utilized for other plasma processes as indicated above.

Plasma processing chamber 100 includes a grounded chamber body 102 coupled to the gas panel 108, one or more RF power sources and a controller 190. The gas panel 108 provides process and other gases to the process region defined in the chamber body 102. At least one of the RF power sources is utilized to sustain the plasma 110 formed from the process gases within the process region, typically to promote substrate processing, chamber or component seasoning and/or coating, and/or chamber cleaning.

A substrate support pedestal 116 disposed within the chamber body 102 below a gas distributor 132. The pedestal 116 may include an electrostatic chuck (not shown) for retaining a substrate 114 below the gas distributor 132.

The electrostatic chuck is driven by a DC power supply to develop an electrostatic force that holds the substrate 114 to the chuck surface, as is conventionally known. Alternatively, the substrate 114 may be retained to the pedestal by clamping, vacuum or gravity.

In various embodiments, the substrate support pedestal 116 is configured as a cathode and is coupled to a plurality of RF power sources. RF power, provided by at least a first RF power source 104, is coupled between the cathode and another electrode, such as the gas distributor 132 or ceiling of the chamber body 102. The RF power excites and sustains a plasma discharge (e.g., a plasma 110) formed from the gases disposed in the processing region of the chamber body 102.

In the exemplary embodiment depicted as plasma processing chamber 100 in FIG. 1, a plurality of RF power sources 104, 106 are coupled to the cathode through a matching circuit 112. The signal generated by the RF power sources 104, 106 is delivered through matching circuit 112 to the substrate support pedestal 116 through a single feed to ionize the gas mixture provided in the plasma processing chamber 100, thereby providing ion energy necessary for performing an etch or other plasma enhanced process. The RF power sources 104, 106 are generally capable of producing an RF signal having a frequency of from about 50 kHz to about 200 MHz and a power between about 0 Watts and about 5000 Watts. Another optional RF source 120 is shown in FIG. 1 and is representative of one or more additional power sources that may be used to control the characteristics of the plasma 110.

The gas distributor 132 may comprise one or more nozzles or a showerhead. The gas distributor 132 is coupled to the gas panel 108 such that gases provided to the gas distributor 132 from the gas panel 108 may introduced into the chamber and, when ignited, form into the plasma 110 utilized for processing the substrate 114.

In one mode of operation, the substrate 114 is disposed on the substrate support pedestal 116 in the plasma processing chamber 100. A process gas and/or gas mixture is introduced into the chamber body 102 through the gas distributor 132 from the gas panel 108. A vacuum pumping system 122 maintains the pressure inside the chamber body 102 while removing etch by-products. The vacuum pumping system 122 typically maintains an operating pressure between about 10 mTorr to about 20 Torr.

A controller 190 is coupled to the various components of the plasma processing chamber 100 and is used to facilitate control of an etch process. The controller 190 generally includes a central processing unit (CPU) 192, a memory 194, and support circuits 196 for the CPU 192. The CPU 192 may be one of any form of computer processor that can be used in an industrial setting for controlling various chambers and subprocessors. The memory 194 is coupled to the CPU 192. The memory 194, or computer-readable medium, may be one or more of readily available memory such as random access memory (RAM), read only memory (ROM), floppy disk, hard disk, or any other form of digital storage, local or remote. The support circuits 196 are coupled to the CPU 192 for supporting the processor in a conventional manner. These circuits include cache, power supplies, clock circuits, input/output circuitry and subsystems, and the like.

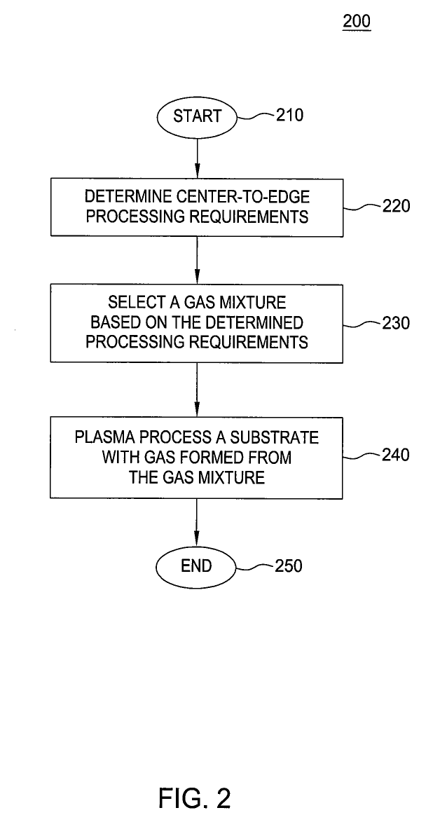

A process, for example a method 200 for plasma processing according to an embodiment of the invention described below with reference to FIG. 2, is generally stored in the memory 194, typically as a software routine. The software routine may also be stored and/or executed by a second CPU (not shown) that is remotely located from the hardware being controlled by the CPU 192. Although the process of the present invention is discussed as being implemented as a software routine, some of the method blocks that are disclosed therein may be performed in hardware as well as by the software controller. As such, the invention may be implemented in software as executed upon a computer system, in hardware as an application specific integrated circuit or other type of hardware implementation, or a combination of software and hardware.

FIG. 2 depicts one embodiment of the method 200 for plasma processing. The method 200 commences with block 210 (start), and proceeds to block 220, wherein center-to-edge plasma processing requirements for a plasma processing procedure to be performed are determined. Block 220 may entail, but is not limited to, performing an analysis on the substrate prior to plasma processing, and/or performing an analysis on a previously processed substrate after the previously processed substrate has undergone plasma processing. The analysis may include at least one of measuring critical dimensions, material thickness, pattern density and/or distribution, material identification and the like. Metrology equipment suitable for performing such analysis is available from Applied Materials, Inc., Nanometrics and others.

After the desired center-to-edge requirements are determined at block 220, a gas mixture composition is selected at block 230. The gas mixture is selected in response to the center-to-edge processing requirements determined at block 220. The gas mixture composition is selected to provide a center-to-edge distribution of plasma species that produce a desired processing result. In one embodiment, the gas mixture composition may be selected utilizing qualitative analysis. Such analysis may include, but is not limited to, historical processing data. Alternatively, the gas ratio required to obtain the desired result may be determined by computational analysis and/or modeling.

At block 240, plasma is formed from the selected gas mixture to plasma process the substrate. In one example, the plasma process is an etch process. The substrate may be plasma processed in the processing chamber 100 as described above or other suitable chamber. In one embodiment, the plasma process performed at block 240 may comprise a plasma deposition process, for example a chemical vapor deposition process or a physical vapor deposition process. In another exemplary embodiment, the plasma process performed at block 240 may comprise a plasma treatment process, for example, a nitridation or a strain engineering process utilizing implantation or hydrogen or nitrogen species.

Optionally, the plasma processing results may be measured in-situ the process to determine if the process is on target to achieve the desired (i.e. determined at block 220) processing results. If the process is determined not to be on target, an adjusted set of center to edge processing requirements may be determined (as described at block 220), an adjusted gas mixture selected (as described at block 230), and/or the plasma processing parameters otherwise adjusted in any suitable manner in order to achieve the original processing requirements.

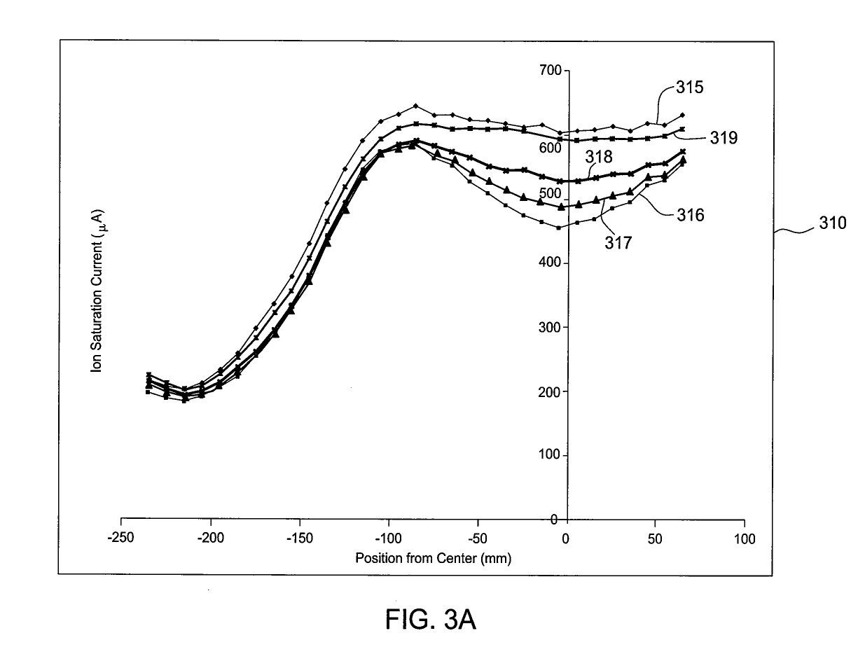

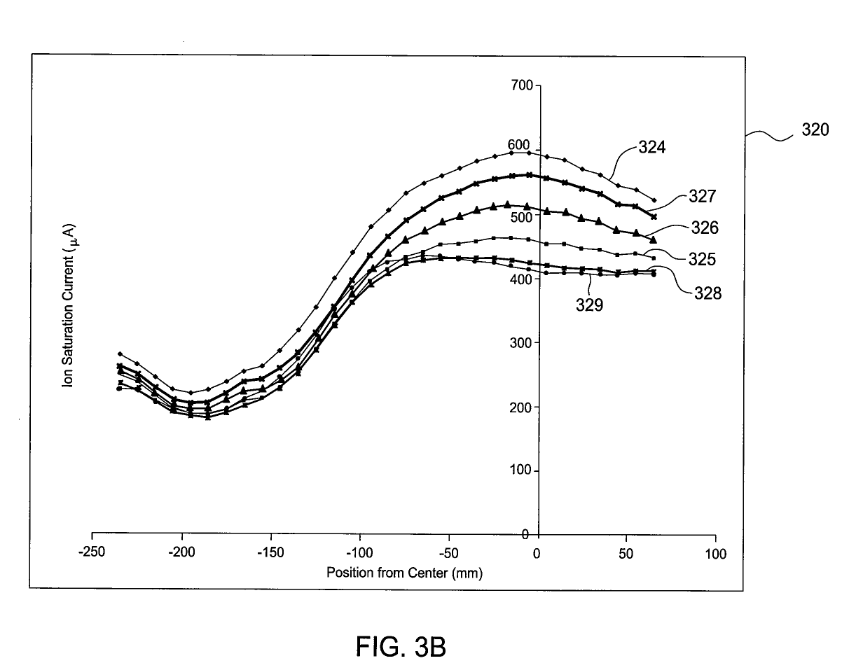

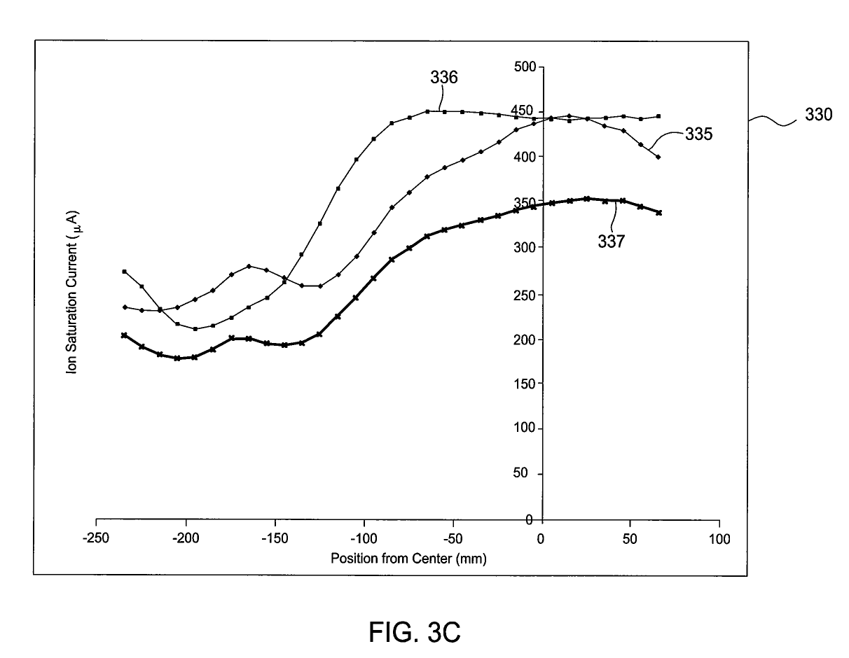

The utility of the invention with respect to three particular exemplary embodiments is demonstrated in FIGS. 3A, 3B and 3C, where charts 310, 320 and 330 respectively display qualitative (measured) results of embodiments of the invention being implemented. Specifically, charts 310, 320, and 330 depict examples of the effective results of mixing a plurality of different ratios of Ar and Xe, on each respective iterations' radial plasma density profiles. As previously mentioned, it is contemplated that other and further gas mixtures, ratios thereof and plasma formation methodologies may be utilized.

The results displayed in charts 310, 320 and 330 were obtained by positioning a Langmuir probe on a linear drive scan approximately 0.5 inches above the surface of a substrate subjected to plasma species mixed according to the invention. The probe was positioned in 10 mm increments from the center of the substrate, out to 235 mm. Ion saturation current was measured by biasing the probe to −100V, from which corresponding electron density profiles were inferred. In each case (charts 310, 320, and 330) the measured plasma was formed utilizing a 500 W electromagnetic source operating at 162 MHz, provided by an RF metrology system such as, but not limited to, RF metrology system 198 of FIGS. 1A-C.

The embodiments represented by traces 315-319 in chart 310 depict ion saturation currents obtained at different radial positions from the center of a substrate for plasmas comprised of different Ar:Xe flow ratios with the plasma processing chamber maintained at 100 mTorr. As examples, trace 315 represents an Ar:Xe flow ration of 2000/0, trace 316 represents an Ar:Xe flow ratio of 1900/100, trace 317 represents an Ar:Xe flow ratio of 1950/50, trace 318 represents an Ar:Xe flow ratio 318 of 1975/25, and trace 319 represents a second test having an Ar:Xe flow ratio of 2000/0. Chart 310 shows electron density being reduced (e.g., reduced ion saturation current) in the center of the substrate when more Xe is added to the gas mixture. The turning of the edge to center ion distribution may have other benefits. For example, by selecting the proper ratio of inert gases, the distribution of ions may be controlled to tuning out standing wave effects without the use of magnets.

Similar to Chart 310, Chart 320 depicts traces 324-324 of ion saturation currents obtained at different radial positions from the center of a substrate for different Ar:Xe flow rations with the plasma processing chamber is maintained at 30 mTorr. As examples, trace 324 represents an Ar:Xe flow ratio of 2000/0, trace 325 represents an Ar:Xe flow ratio of 1900/100, trace 326 represents an Ar:Xe flow ratio of 1950/50, trace 327 represents an Ar:Xe flow ratio of 1975/25, trace 328 represents an Ar:Xe flow ratio of 1800/200, and trace 329 represents an Ar:Xe ratio 329 of 1700/300. Similar flattening and suppression of center electron density from the addition of Xe to that displayed in Chart 310 is readily apparent.

Chart 330 depicts qualitative results of an embodiment wherein O₂ is added to the gas mixture as an etchant. Chart 330 depicts traces 335-337 of saturation currents obtained at different radial positions from the center of a substrate at different Ar:Xe flow ratios with the plasma processing chamber maintained at 40 mTorr. 500 sccm of O₂ is present in the gas mixtures represented by traces 335-337. As examples, trace 335 represents an Ar:Xe flow ratio of 2000/0, trace 336 represents an Ar:Xe flow ratio of 1700/300 and trace 337 represents an Ar:Xe flow ratio of 1700/300. Data for trace 336 was obtained with 750 W coupled to the plasma. Data for traces 335 and 337 was obtained with 500 W coupled to the plasma. Chart 330 demonstrates that controlling center-to-edge distribution by determining a gas mixture comprising a plasma is still effective in the presence of an electronegative etchant (e.g., O₂).

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for plasma processing comprising:
determining plasma processing center to edge profile requirements of a substrate; and
selecting a ratio of two inert gases to be provided as a gas mixture to a plasma processing chamber in response to the plasma processing center to edge profile requirements.

2. The method of claim 1, wherein determining comprises at least one of measuring the substrate prior to processing or measuring a previously processed substrate.

3. The method of claim 1 further comprising etching the substrate using a plasma formed from the gas mixture.

4. The method of claim 1 further comprising depositing a layer of material on the substrate using a plasma formed from the gas mixture.

5. The method of claim 1 further comprising treating the substrate with a plasma formed from the gas mixture.

6. The method of claim 1, wherein the two inert gases comprise Argon and Xenon.

7. The method of claim 6, wherein one of the inert gases is present as a trace in the gas mixture.

8. The method of claim 6, wherein Xenon is present as a trace in the gas mixture.

9. The method of claim 1 further comprising supplying an etchant gas with the gas mixture.

10. A method for plasma processing a substrate, comprising:
determining center to edge plasma processing requirements;
providing a gas mixture having a ratio of two inert gases selected to regulate a spatial distribution of species within a plasma, the ratio selected in response to the center to edge plasma processing requirements; and
plasma processing the substrate in the presence of a plasma formed from the gas mixture.

11. The method of claim 10, wherein determining center-to-edge processing requirements comprises at least one of:
performing an analysis on the substrate prior to said plasma processing; or
performing an analysis on a previously processed substrate.

12. The method of claim 10, wherein plasma processing comprises at least one of:
etching the substrate;
depositing a layer on the substrate; or
plasma treating the substrate.

13. The method of claim 10, wherein the two inert gases comprise Argon and Xenon.

14. The method of claim 10, wherein one of the two inert gases is present as a trace relative to the other inert gas in the gas mixture.

15. The method of claim 13, wherein Xenon is present as a trace relative to Argon.

16. The method of claim 10, further comprising:
analyzing the substrate in-situ processing; and
adjusting the ratio of inert gases in response to the analysis.

17. The method of claim 10, wherein the mixture of the two inert gases further comprises an etchant.

18. The method of claim 10, wherein the mixture further comprises a deposition precursor.

19. A method for plasma processing a substrate comprising:
providing a gas mixture to a processing chamber, the gas mixture comprising a ratio of two inert gases selected to compensate for standing wave effects on a plasma formed in the processing chamber;
forming a plasma from the gas mixture; and
processing a substrate in the processing chamber in the presence of the plasma.

20. A plasma processing system comprising:
a chamber body suitable for maintaining a vacuum therein;
a substrate support disposed in an internal volume of the chamber body;
a gas distribution system configured to provide a gas mixture to the internal volume of the chamber body;
a power application system configured to maintain a plasma formed from the gas mixture within the internal volume of the chamber body;
a controller coupled to the gas distribution system; and
computer readable media containing instructions which, when executed by the controller, cause the processing system to perform a plasma process on a substrate disposed on the substrate support, the process comprising:
proving at gas mixture from the gas distribution system to the internal volume, the gas mixture having a ratio of two inert gases selected to regulate a spatial distribution of species within a plasma, the ratio selected in response to center to edge plasma processing requirements;
providing power from the power application system suitable to maintain a plasma formed form the gas mixture; and
plasma processing a substrate in the presence of the plasma formed from the gas mixture.
